(19) United States
(12) Patent Application Publication
(10) Pub. No.: US 2020/0352135 A1
(43) Pub. Date: Nov. 12, 2020

(54) AUTOMATIC PET ATTENTION DEVICE

(71) Applicant: Duane Reynolds, Avon, IN (US)

(72) Inventor: Duane Reynolds, Avon, IN (US)

(21) Appl. No.: 16/870,839

(22) Filed: May 8, 2020

Related U.S. Application Data
(60) Provisional application No. 62/845,923, filed on May 10, 2019.

(51) Int. Cl. A01K 15/02; B25J 9/16

(52) U.S. Cl. CPC A01K 15/021; B25J 9/1633; A01K 15/025

(57) ABSTRACT

A method for providing automatic petting attention to unsupervised pets, including clamping an automatic pet-tending apparatus to a predetermined desired location and engaging the plug with an AC power source. The automatic pet-tending apparatus further includes a motor, a rotor arm operationally connected to the motor, a power source connected in electric communication with the motor, a switch operationally connected to the motor, a roller head engaged with the rotor arm, a clamp operationally connected to the motor and power source, and a power cord engaged in electric communication with the power source and terminating in a plug. An animal may position itself adjacent the roller head and apply an upward urging force against the switch to energize the motor. The motor will be deenergized upon departure of the animal and cessation of the upward urging force on the switch.

### CROSS-REFERENCE TO RELATED APPLICATIONS

This application claims the benefit under 35 U.S.C. § 119(e) of U.S. Patent Application No. 62/845,923, filed on May 10, 2019, which is incorporated herein by reference in its entirety.

### TECHNICAL FIELD

The present novel technology relates generally to animal care, and, more particularly, to an automatic device for providing attention to pets when humans are unavailable.

### BACKGROUND

Pet owners naturally want to keep their pets healthy and happy. Often, however, pets spend time home alone when the it owners are at work, at school, or otherwise out of the house. While it is relatively simple to keep pets well fed and watered while alone and awaiting the return of their people, it is less straightforward to provide attention to the lonely pets. By definition, pets cannot receive attention from their owners while the owners are away.

Thus, there is a need for providing lonely pets with attention while the pet owners are away from home. The present novel technology addresses this need.

### BRIEF DESCRIPTION OF THE DRAWINGS

FIG. 1 is a top view of a first embodiment automatic animal petting device of the present novel technology.

FIG. 2 is a side view of the embodiment of FIG. 1.

FIG. 2 is a top view of a second embodiment automatic animal petting device of the present novel technology.

FIG. 4 is a side view of the embodiment of FIG. 3.

The details of one or more embodiments of the subject matter described in this specification are set forth in the accompanying drawings and the description below. Other features, aspects, and advantages of the subject matter will become apparent from the description, the drawings, and the claims.

Like reference numbers and designations in the various drawings indicate like elements.

### DETAILED DESCRIPTION

For the purposes of promoting an understanding of the principles of the novel technology and presenting its currently understood best mode of operation, reference will now be made to the embodiments illustrated in the drawings and specific language will be used to describe the same. It will nevertheless be understood that no limitation of the scope of the novel technology is thereby intended, with such alterations and further modifications in the illustrated device and such further applications of the principles of the novel technology as illustrated therein being contemplated as would normally occur to one skilled in the art to which the novel technology relates.

As used in the specification and the claims, the singular forms “a,” “an” and “the” include plural referents unless the context clearly dictates otherwise. Ranges may be expressed in ways including from “about” one particular value, and/or to “about” another particular value. When such a range is expressed, another implementation may include from the one particular value and/or to the other particular value. Similarly, when values are expressed as approximations, for example by use of the antecedent “about,” it will be understood that the particular value forms another implementation. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not. Similarly, “typical” or “typically” means that the subsequently described event or circumstance often though may not occur, and that the description includes instances where said event or circumstance occurs and instances where it does not.

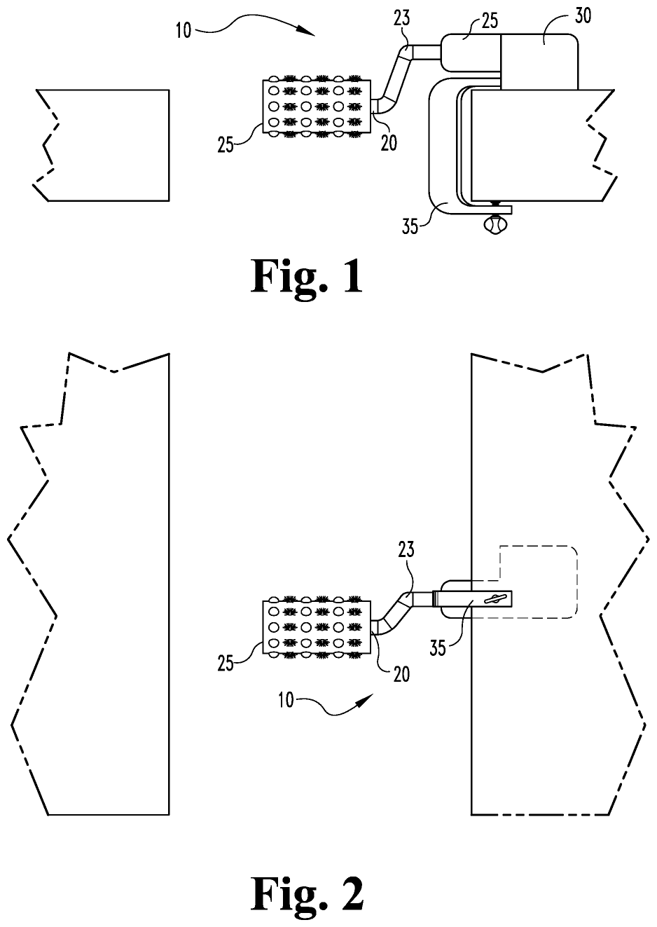

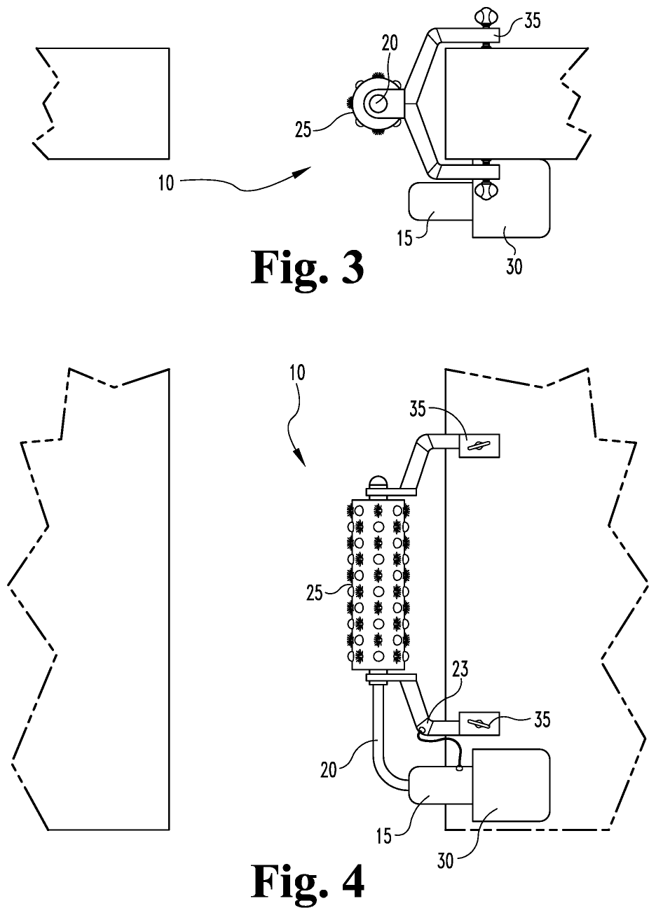

The novel technology shown in FIGS. 1-5 relates to a pet-activated or automatic scratching/massaging/petting system 10. The system 10 includes a motor 15, a rotor arm 20, a switch 23, a roller head 25, a power source 30, and a clamp 35 for affixing the system 10 to a desired location.

The clamp 35 is typically connected to the power source 30 and/or the rotor arm 20 and/or the switch 23, and is affixable to any desired stationary object, such as a table, a doorway, a wall, or the like. The clamp 35 may be affixed such that the rotor arm 20 extends horizontally or vertically. A roller head 25 is engaged, typically slidingly engaged and held with an interference fit, over the rotor arm 20 and provides an engagement surface for the animal. The roller head 25 may have a brush or bristled surface, a knurled surface, or the like surface texture to provide different sensations to the animal. In a typical embodiment, a plurality of different roller heads 25 re provided for selection.

The motor 15 is typically a DC electric motor, and the power source 30 is typically a DC converter that is plugged into a standard 110 AC outlet via a power cord 37 extending from the power source 30. Typically, the power cord 37 is engaged in electric communication with the power source 30 and terminates in a plug 39.

A switch 23 is operationally connected to the power source 30 and oriented such that an upwardly exerted force provided by the animal the energizes the motor 15 to turn the rotor arm 20. In some embodiments, the rotor arm 20 and the switch 23 are unitary. Once the animal is satisfied and walks away or otherwise disengages from urging the switch 23 to actuate the motor 15, the motor 15 is disengaged and the system 10 is idle until once again actuated.

In some embodiments, the motor 15 may be remotely actuated/deactuated such as by a remote control 40 operationally connected to a receiver 45 operationally connected to the power source 30, such that the pet owner may start or stop rotation of the rotor arm 20 as desired.

In other embodiments, a mounting plate 50 for receiving the clamp 35 is provided and affixed to a location otherwise unsuited for receiving the clamp 35.

In yet other embodiments, the switch 23 is a motion sensor, a sound sensor, or the like instead of a simple mechanical switch 23, such that the approach of the animal or a bark, growl, or purr is sufficient to actuate the rotor arm 20. The rotor arm 20 remains actuated for a predetermined length of time or may be deactuated by the animal moving away from the system 10.

In operation, the system 10 is clamped to a predetermined location and the plug 37 is operationally connected to an A/C outlet. An animal, such as a dog, cat, rabbit, or the like positions itself against the roller head 25 and energizes the system 10, such as by pushing against the switch 23, typically with an upwardly urging force to move the switch 23 against the pull of gravity to energize the motor 15. The motor 15 is energized and the roller head 25, typically slowly, turns against the animal to provide a pleasing sensation. Once satisfied, the animal disengages from the switch 23 and roller head 25, deactuating the system 10.

While the invention has been illustrated and described in detail in the drawings and foregoing description, the same is to be considered as illustrative and not restrictive in character. It is understood that the embodiments have been shown and described in the foregoing specification in satisfaction of the best mode and enablement requirements. It is understood that one of ordinary skill in the art could readily make a nigh-infinite number of insubstantial changes and modifications to the above-described embodiments and that it would be impractical to attempt to describe all such embodiment variations in the present specification. Accordingly, it is understood that all changes and modifications that come within the spirit of the invention are desired to be protected.

What is claimed is:

1. An automatic apparatus for petting an animal, comprising:
a motor;
a rotor arm operationally connected to the motor;
a power source connected in electric communication with the motor;
a switch operationally connected to the motor;
a roller head engaged with the rotor arm;
a clamp operationally connected to the motor and power source;
a power cord engaged in electric communication with the power source and terminating in a plug;
wherein the automatic apparatus is clamped to a fixture, the switch is actuatable by an upwardly directed force thereupon.

2. The automatic apparatus of claim 1, wherein the motor is a DC motor and wherein the power source is an AC to DC converter.

3. The automatic apparatus of claim 1, further comprising:
a plurality of roller heads, each respective roller head having a different surface texture.

4. A method for providing automatic petting attention to unsupervised pets, comprising:
clamping an automatic pet-tending apparatus to a predetermined desired location, wherein said automatic pet-tending apparatus further comprises;
a motor;
a rotor arm operationally connected to the motor;
a power source connected in electric communication with the motor;
a switch operationally connected to the motor;
a roller head engaged with the rotor arm;
a clamp operationally connected to the motor and power source;
a power cord engaged in electric communication with the power source and terminating in a plug;
engaging the plug with an AC power source;
wherein an animal may position itself adjacent the roller head and apply an upward urging force against the switch to energize the motor; and
wherein the motor will be deenergized upon departure of the animal and cessation of the upward urging force on the switch.
